(19) United States
(12) Patent Application Publication
(10) Pub. No.: US 2016/0073644 A1
(43) Pub. Date: Mar. 17, 2016

(54) AUTOMATED PROCESSING AND PLACEMENT OF THREE-DIMENSIONAL FOOD INGREDIENTS ON A SURFACE OF AN OBJECT

(71) Applicant: Roger Dickey, (US)

(72) Inventor: Roger Dickey, San Francisco, CA (US)

(21) Appl. No.: 14/486,436

(22) Filed: Sep. 15, 2014

(51) Int. Cl. A21C 9/08; B25J 11/00

(52) U.S. Cl. CPC A21C 9/08; B25J 11/0045

(57) ABSTRACT

A system and related method for placing three-dimensional food ingredients on a surface of an object, such as a pizza or other good to be baked that includes a memory for storing computer executable instructions, a processing device to execute the instructions, dispensing devices that are each structured and arranged to contain one food ingredient, and a distribution device that is structured and arranged to place food ingredients at discrete locations on the surface of the object in accordance with an input design that is replicated using the ingredients.

### BACKGROUND OF THE INVENTION

Pizzas, cakes, and other baked goods represent tremendously large markets in the U.S. and internationally. Traditionally, these baked goods have plain or blank surfaces or are manually decorated by food preparation workers. Research suggests that customers prefer and would pay more for decorated food; however, existing decorating processes are expensive due mainly to the high cost of labor. Problematically, their manual, one-off nature results in significant variance between items and limits options for customization.

Edible screen prints that use food coloring ink and the like provide a custom design that can be placed as a unit on baked goods such as cakes. Typically, an image is transferred to a flat screen print and the entire screen is then applied to the baked good. Hence, screen printing involves a two-dimensional rendering of a source image onto a surface of a baked good. In a related process, a customer-supplied design can be transferred to decorate the surface of a fluid drink, e.g., a latte, or the foam on a drink.

Some cake shops and pizza shops offer their customers a custom-made product in which a food preparation worker manually decorates the baked good in accordance with the customer's preferences. This, however, is a labor intensive process that produces a unique, one-off, human-created design with each order.

Some companies, e.g., 3D Systems, Inc. of Rock Hill, S.C., have experimented with three-dimensional printing technology to create an edible, three-dimensional object, e.g., a sugar “cube,” from an inputted three-dimensional model. Such objects can be eaten directly or added to another edible object, e.g., as a decoration.

It would be desirable to provide a better, more economical process to decorate objects, e.g., baked goods, automatically, using a plethora of items, e.g., ingredients, following a complex design or pattern coming from almost any source. It would also be desirable to provide a decorating process that is easily repeatable with low variance and that allows for real-time customization.

### SUMMARY OF THE INVENTION

In a first aspect, a system for placing three-dimensional food ingredients on a surface of an object, e.g., a good to be baked, is disclosed. In some embodiments, the system includes memory for storing computer executable instructions and for storing image data for a design to be placed on the surface of the object, a processing device that is configured and arranged to execute the computer executable instructions stored in the memory, dispensing devices (each of which is structured and arranged to contain a three-dimensional food ingredient), and a distribution device, e.g., a robotic arm, that is structured and arranged to place, in response to an instruction from the processing device, three-dimensional food ingredients from the dispensing devices at discrete locations on the surface of the object. In some implementations, the dispensing devices are elongate, hollow tubes that, in cross section, are circular, oval, rectangular, hexagonal, octagonal, and/or triangular. Moreover, each tube may contain a food ingredient that has an associated color. In some variations, each tube includes a delivery chute that delivers some or all of the food ingredient contained in the tube.

The dispensing devices may include a mechanical connection that is adapted to mate with the distribution device and/or an electrical connection that is adapted to mate with the distribution device. The system may further include a dynamic dispenser that is configured and arranged to replenish the dispensing devices with a corresponding three-dimensional food ingredient.

In other variations, the system further includes an image processing device that is configured and arranged to generate, based on an input image, the image data for the design to be placed on the surface of the object. In some implementations, the memory is configured to store historical data for previously completed images, prepared image data, and/or input image data.

In a second aspect of the present invention, a method for placing three-dimensional food ingredients on a surface of an object is disclosed. In some embodiments, the method includes receiving an image of a design to be placed on the surface of the object, associating one or more discrete portions of the image with one of the three-dimensional food ingredients, determining vectors for delivering the three-dimensional food ingredients to discrete locations on the surface of the object, and placing the three-dimensional food ingredients at the discrete locations on the surface of the object. In some implementations, associating the discrete portion(s) of the image may include comparing a color in the image with food ingredient colors.

In another implementation, receiving the image of the design may include receiving a scan of a document displaying the image, receiving a previously used image design, and/or receiving a prepared design.

In some variations, the method includes calculating a cooking time for the object. For example, calculating the cooking time may involve taking into account all of the three-dimensional food ingredients that have been placed on the surface of the object.

In a third aspect of the present invention, an article of manufacture is disclosed. In some embodiments, the article of manufacture includes a non-transitory machine-readable medium on which machine-readable instructions are stored. When executed by a machine, the machine-readable instructions configure the machine to receive an image of a design to be placed on a surface of an object, associate one or more discrete portions of the image with a three-dimensional food ingredient, determine vectors for delivering three-dimensional food ingredients to discrete locations on the surface of the object, and place the three-dimensional food ingredients at the discrete locations on the surface of the object. In some implementations, associating the discrete portion(s) of the image includes comparing a color in the image with a color of each of the three-dimensional food ingredients.

In other implementations, the article of manufacture further includes instructions that, when executed by the machine, configure the machine to calculate a cooking time for the object. For example, in calculating the cooking time, all of the three-dimensional food ingredients that have been placed on the surface of the object may be taken into account. In other variations, the article of manufacture further includes instructions that, when executed by the machine, configure the machine to cause the three-dimensional food ingredients to be replenished.

### BRIEF DESCRIPTION OF THE DRAWINGS

The accompanying drawings are not necessarily drawn to scale. In the drawings, each identical or nearly identical component that is illustrated in various figures is represented by a like numeral. For purposes of clarity, not every component is labeled in every drawing. In the drawings:

FIG. 1 shows a block diagram of an illustrative embodiment of a system for placing three-dimensional items on a surface of an object in accordance with the present invention.

FIG. 2A shows an illustrative embodiment of dispensing and distribution devices of a first system in accordance with the present invention.

FIG. 2B shows an illustrative embodiment of dispensing and distribution devices of a second system in accordance with the present invention.

FIG. 2C shows an illustrative embodiment of a dispensing and distribution devices of a third system in accordance with the present invention

FIG. 3 shows an illustrative embodiment of an ingredient dispensing device for the systems of FIG. 2A and FIG. 2B in accordance with the present invention.

FIG. 4 shows a flow chart of an illustrative method for decorating the surface of an object with three-dimensional food ingredients.

### DETAILED DESCRIPTION OF THE INVENTION

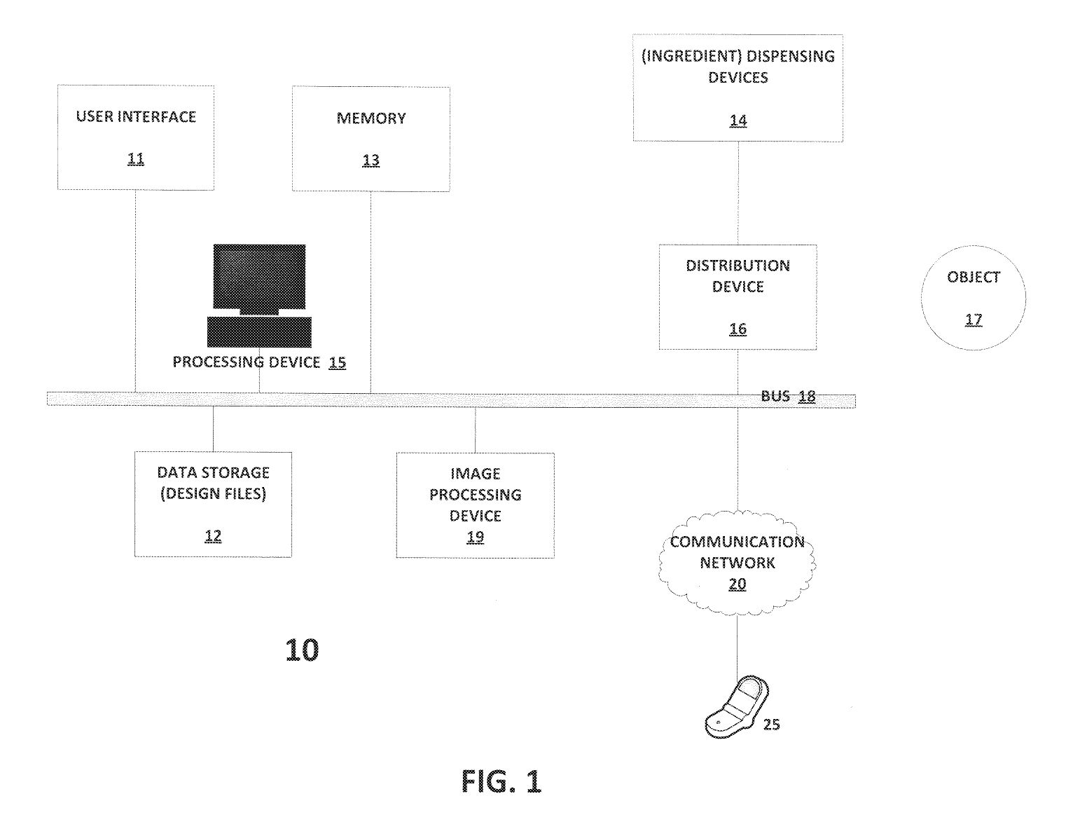

Referring to FIG. 1, an illustrative embodiment of a system 10 for placing three-dimensional items, e.g., food ingredients, on a surface of an object 17, e.g., a baked good, pizza, cake, and the like, will be described. For expediency, the description assumes that the object 17 is a pizza and that the three-dimensional items correspond to a myriad of prepared pizza ingredients. Those of ordinary skill in the art can appreciate that the invention can be practiced on other objects 17 that include, without limitation, other baked goods or prepared foods using other items that include, without limitation, other ingredients and prepared foods.

As depicted in FIG. 1, the system 10 may include a data storage device 12, a processing device 15, a plurality of dispensing devices 14, and a distribution device 16, which can all be electrically and electronically connected or coupled by an interconnection element, e.g., one or more buses 18. The bus 18 may include one or more physical buses, e.g., between components that are integrated within a same machine, but may include any communication coupling between system elements including specialized or standard computing bus technologies such as IDE, SCSI, PCI, and InfiniBand. The bus 18 may further connect the processing device 15 to other system elements, e.g., the communication network 20. Thus, the bus 18 enables communication, e.g., of data and/or instructions, to be exchanged between elements of the processing device 15 as well as between components of the overall system 10.

The memory 13 may include a computer readable and writeable nonvolatile storage medium in which instructions are stored that define a program to be executed by the processing device 15. More specifically, in some variations, the memory 13 is adapted to store information that includes computer-executable instructions for enabling the methods and processes described herein. Memory 13 may include information that is recorded on or in the medium, and this information may be processed by the program. More specifically, the information may be stored in one or more data structures specifically configured to conserve storage space or increase data exchange performance. The instructions may be persistently stored as encoded signals and the instructions may cause the processing device 15 to perform any of the functions described herein. The medium may be, for example, an optical disk, a magnetic disk or flash memory, among others.

In operation, the processing device 15 or some other controller may cause data to be read from the nonvolatile recording medium into another memory, such as the data storage device 12, that allows for faster access to the information by the processing device 15 than does the storage medium included in memory 13. The data may be located in data storage system 12 or in memory 13; however, the processing device 15 may manipulate the data within the memory 13, and then copy the data to the medium associated with data storage system 12 after processing is complete. A variety of components may manage data movement between the memory 13 and the data storage system 12 and the invention is not limited thereto. Further, the invention is not limited to a particular memory system or storage system.

Various aspects and functions described herein may be implemented on one or more processing devices 15 as software, as hardware, as firmware, or as any combination thereof. Thus, aspects in accord with the present invention may be implemented within methods, acts, systems, system elements, and components using a variety of hardware and software configurations. Hence, the invention is not limited to any particular distributed architecture, network or communication protocol. There are many examples of processing devices 15 currently in use, including network appliances, personal computers, tablet computers, laptop computers, workstations, mainframes, networked clients, servers, media servers, application servers, database servers, and web servers. Other examples of processing devices 15 include mobile computing devices, such as cellular phones, personal digital assistants, and network equipment, such as load balancers, routers and switches. Further, aspects in accord with the present invention may be located on a single processing device 15 or may be distributed among a plurality of processing devices 15 connected to one or more communications networks 20.

The processing device 15 may be structured and arranged to perform a series of instructions that result in manipulated data. For that purpose, the processing device 15 may be a commercially available processing device 15, such as an Intel Pentium, Motorola PowerPC, SGI MIPS, Sun UltraSPARC, or Hewlett-Packard PA-RISC processing device 15, but may be any type of processing device 15 or controller as many other processing devices 15 and controllers are available.

The processing device 15 may include an operating system that manages at least a portion of the hardware elements included in the system 10. For example, the processing device 15 may execute an operating system that is a Windows-based operating system, e.g., Windows NT, Windows 2000 (Windows ME) or the Windows XP operating systems available from Microsoft Corporation, a MAC OS System X operating system available from Apple Computer, a Linux-based operating system, e.g., the Enterprise Linux operating system available from Red Hat, Inc., a Solaris operating system available from Sun Microsystems, or a UNIX operating system available from various sources. Many other operating systems may be used, and embodiments are not limited to any particular implementation.

The processing device 15 and operating system together define a computer platform for which application programs in high-level programming languages may be written. These component applications may be executable, intermediate, e.g., C−, or interpreted code that communicates over the communication network 20, e.g., the Internet, using a communication protocol, e.g., TCP/IP. Similarly, aspects in accord with the present invention may be implemented using an object-oriented programming language, such as SmallTalk, Java, C++, Ada, or C# (C-Sharp). Other object-oriented programming languages may also be used. Alternatively, functional, scripting, or logical programming languages may be used.

Additionally, various aspects and functions in accord with the present invention may be implemented in a non-programmed environment, e.g., documents created in HTML, XML or other format that, when viewed in a window of a browser program, render aspects of a graphical-user interface or perform other functions. Further, various embodiments in accord with the present invention may be implemented as programmed or non-programmed elements, or any combination thereof. For example, a Webpage may be implemented using HTML while a data object called from within the Webpage may be written in C++. Thus, the invention is not limited to a specific programming language and any suitable programming language could be used.

Aspects of the system 10 may be implemented using existing commercial products, such as, for example, database management systems including SQL Server available from Microsoft Corporation of Seattle, Wash., Oracle Database from Oracle of Redwood Shores, Calif., and MySQL from MySQL AB of Uppsala, Sweden, or integration software such as Web Sphere middleware from IBM of Armonk, N.Y. A processing device 15 running, for example, SQL Server may be able to support both aspects in accord with the present invention and databases for sundry applications not within the scope of the invention.

Aspects of the invention are not limited to being implemented on the processing device 15 as shown in FIG. 1. For instance, the system 10 may include specially-programmed, special-purpose hardware, such as, for example, an application-specific integrated circuit (ASIC) tailored to perform a particular operation disclosed herein. Another embodiment may perform the same function using several general-purpose computing devices running MAC OS System X with Motorola PowerPC processing devices 15 and several specialized computing devices running proprietary hardware and operating systems.

Processing device memory, e.g., data storage 12, may be used for storing programs and data during operation of processing device 15. Data storage 12 may include any device for storing data, such as a disk drive or other non-volatile storage device. Alternatively, data storage 12 may be a relatively high performance, volatile, random access memory (RAM) such as a dynamic random access memory (DRAM) or static random access memory (SRAM). Various embodiments in accord with the present invention may organize data storage 12 into particularized and, in some cases, unique structures to perform the aspects and functions disclosed herein.

The system 10 also may include one or more interface devices 11 such as input devices, output devices, and combination input/output devices. Interface devices 11 enable processing devices 15 to exchange information and, moreover, communicate with the distribution device 16 and dispensing device 14 as well as with external entities, e.g., other systems or servers 25. Advantageously, interface devices 11 are configured to receive input or to provide output with both internal and external sources. Examples of interface devices 11 include keyboards, mouse devices, trackballs, microphones, touch screens, printing devices, display screens, speakers, network interface cards, etc.

In some embodiments of the present invention, the system 10 includes an image processing device 19, which may also be electrically and electronically connected, e.g., to the processing device 15, via one or more buses 18. The image processing device 19 can be any device that acquires an image and translates the acquired image into digital image data. For example, the image processing device 19 may include, without limitation, an image input device, a scanning device, a photocopier, a digital camera, and/or an imaging device that is an integral part of a cellphone, a tablet computer, or a personal computer.

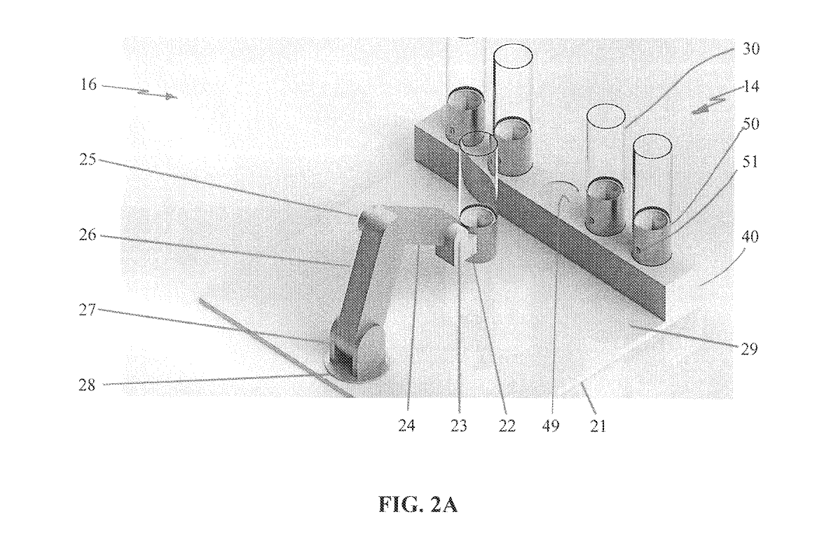

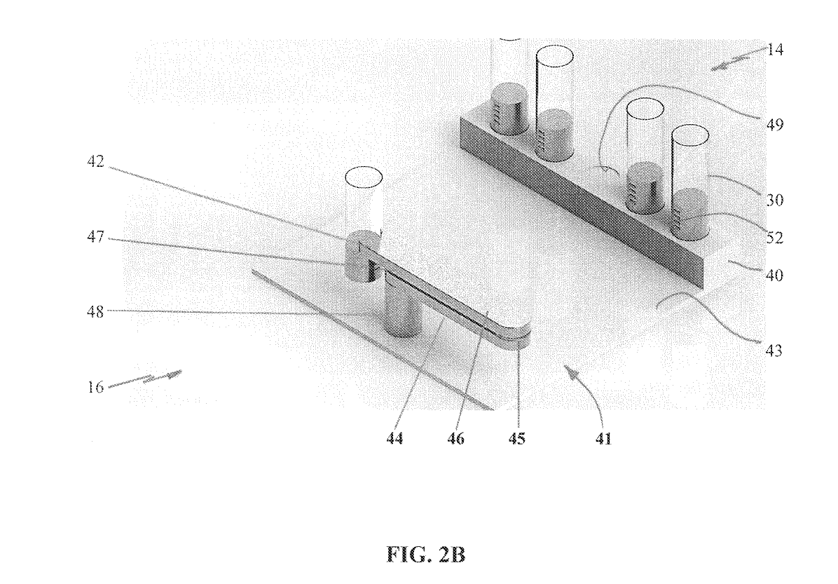

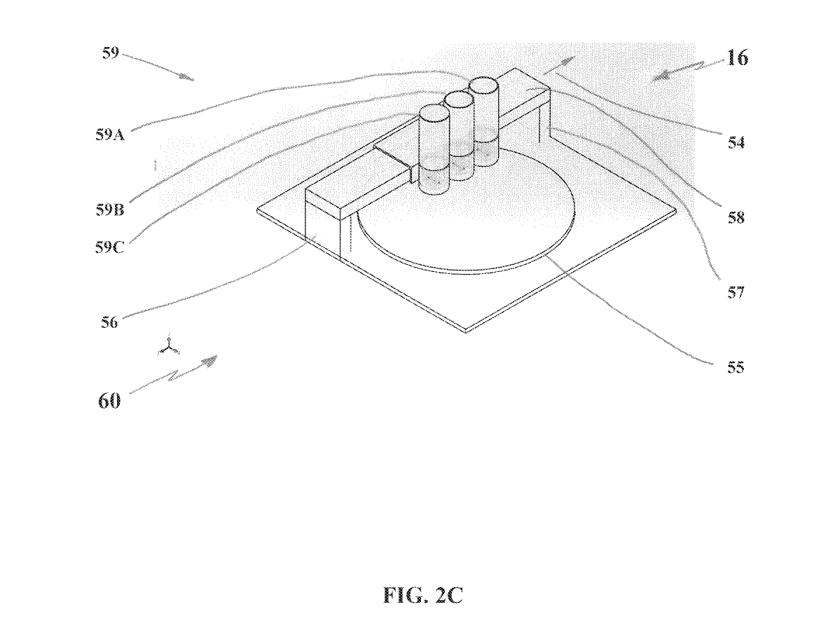

Various embodiments of distribution device 16 and dispensing devices 14 are shown in FIGS. 2A and 2B. In some embodiments, the dispensing devices 14 include a plurality of containers 30 that are structured and arranged to contain prepared food ingredients. The containers 30 may be stored in openings 49 in a dispenser rack 40 such that the distribution device 16 can easily reach each of the containers 30. In operation, each container 30 contains a single food ingredient; however, there may be more than one container 30 that contains a particular ingredient. In some applications, the size, shape, weight, and mechanical and electrical interfaces of the individual ingredient dispensers 30 may be the same or substantially the same. For example, in some implementations, the ingredient containers 30 are elongate, hollow tubes having cross-sections that may be, for purposes of illustration and not limitation, circular, substantially circular, oval, triangular, rectangular, rounded rectangular, pentagonal, hexagonal, octagonal, polygonal, and so forth. The cross-section of the tubes may be selected to facilitate distribution of the food ingredient contained therein.

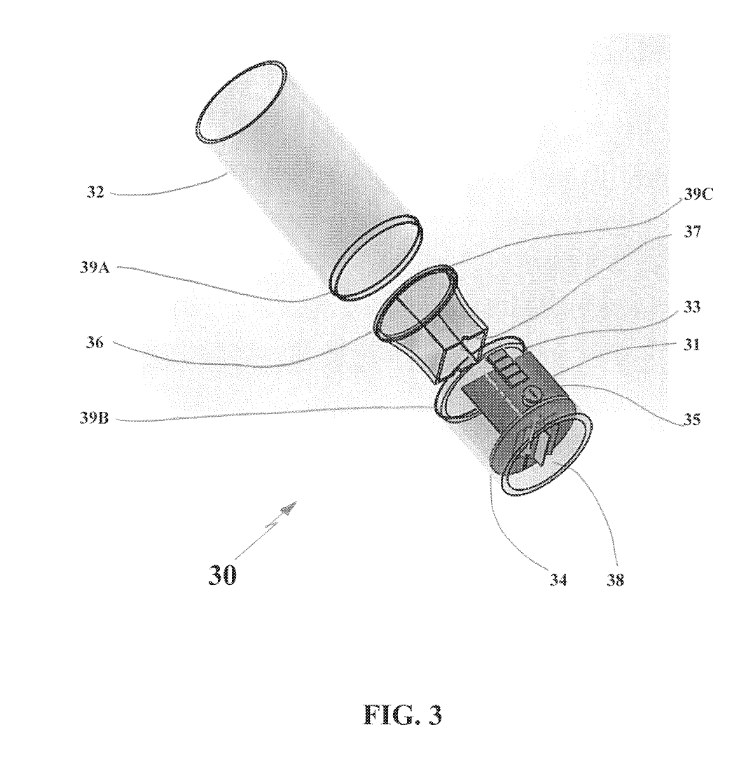

Referring to FIG. 3, an exploded view of a single container 30 is shown. The container 30 may include an ingredient tube 32, an ingredient funnel assembly 36, and a device housing 34. Each of the ingredient tube 32, ingredient funnel 36, and device housing 34 may be made out of plastic, glass or any other lightweight material that can be easily washed and sterilized. In some implementations, the ingredient tube 32 includes a rim portion 39A that is structured and arranged to create a tight, interference fit with a rim portion 39B of the device housing 34. Alternatively, each of the rim portions 39A and 39B may be threaded so that one can be screwed tightly onto the other. In one variation, the rim portion 39B of the device housing 34 includes a shoulder portion that is structured and arranged to support a rim portion 39C of the funnel assembly 36, so that an opening 37 of the funnel assembly 36 is maintained at a desired distance from a dispensing mechanism 38 in the device housing 34.

As shown, in FIGS. 2A and 2B, the device housing 34 may also include an outer portion or sleeve 50 that is made of a ferro-magnetic material for use with a magnetic distribution device 16 described in greater detail below. The outer portion or sleeve 50 may be designed to create an interference fit with the device housing 34. In some implementations, the outer portion or sleeve 50 includes an opening 51 (FIG. 2A) through which a mechanical interface 35 (FIG. 3) is exposed and/or the outer portion or sleeve 50 includes a plurality of openings 52 (FIG. 2B) through which a plurality of electrical data contacts 33 (FIG. 3) are exposed. As an alternative to the latter, electrical data contacts 33 may be integrated into the outer portion or sleeve 50.

With reference again to FIG. 3, the device housing 34 may be structured and arranged to accommodate the funnel assembly 36, a printed circuit board (PCB) 31, a plurality of electrical data contacts 33, a rotatable, mechanical interface 35, and a dispensing vane 38. The PCB 31 may be electrically coupled to the electrical data contacts 33, while the dispensing vane 38 may be operationally coupled to the mechanical interface 35. In operation, a mechanical rod disposed in a gripper assembly 22 (FIG. 2A) may mate with the mechanical interface 35. To dispense the contents of the container 30, the mechanical rod and mechanical interface 35 may be selectively rotated to open one or more ingredient release mechanisms (e.g., dispensing vanes 38) to a desired opening dimension. In some embodiments of the invention, the ingredient containers 30 are designed to drop one ingredient at a time at the same relative position and attitude. For example, a first ingredient may always fall from the center portion of the dispenser vane 38, from the left/bottom portion of the dispenser vane 38, and/or from the right/top portion of the dispenser vane 38, to standardize the consistency and predictability of the design application. Although FIG. 3 shows that there are multiple (three) dispensing vanes 38, this is done for illustrative purposes only. Accordingly, there may be more or fewer than three dispensing vanes 38. For example, a dispensing mechanism 38 for pepperoni would differ from the dispensing mechanisms 38 for pizza sauce, green peppers, and so forth. In another variation, the mechanical system may be replaced by a magnetic system that is discussed in greater detail below.

In one embodiment, the electrical data contacts 33 are structured and arranged to mate with corresponding electrical data contacts on the gripper assembly 22. The dispenser electrical data contacts 33 when mated with the gripper assembly data contacts identify the contents of the container 30, which ensures that the distribution device 16 does not deliver the wrong ingredient to some region of the pizza.

For high-volume production, due to the limited size of the dispensing containers 30, frequent replenishment is necessary. Although replenishment may be performed manually, dynamic, automatic replenishment is desirable. In one embodiment, a replenishment system includes another robotic actuator arm that is structured and arranged to grab empty or nearly empty dispensing containers 30 that are not being used and to position the dispensing containers 30 proximate large compartments in which ingredients are manually added and stored. Re-filling the containers 30 may, for example, include placing the top of the ingredient tube 32 beneath a dispensing vane in the large compartment and gravity feeding a measured volume of the ingredient into the ingredient tube 32 and funnel assembly 36. Alternatively, the robotic actuator arm may grab an ingredient compartment and locate the dispensing vane of the compartment over the open end of the ingredient tube 32 and gravity feed a measured volume of the ingredient into the ingredient tube 32 and funnel assembly 36.

In one embodiment, the distribution device 16 is structured and arranged to place a plurality of prepared food ingredients at discrete locations on the surface of a pizza to replicate a desired image. The distribution device 16 may be a stand-alone device having its own processing device, memory, data storage, and user interface; however, for ease of disclosure, it will be assumed that the distribution device 16 is connected to and operationally controlled by the devices described hereinabove via at least one bus 18.

FIGS. 2A and 2B show a pair of representative and illustrative embodiments of the distribution device 16. Those skilled in the art can appreciate that there are a myriad of ways of distributing items from a height (z-axis) over a planar or substantially flat xy-plane and that those shown illustratively in the figures are just two possibilities. Each of the illustrative distribution devices 16 includes a gripper assembly 22, 42, a positioning device, e.g., an articulating robotic arm 21, 41, and a main support 28, 48. In some embodiments, the proximal end of the robotic arms 21, 41 is rotationally and operationally attached to the main support 28, 48, while the distal end is rotationally and operationally attached to the gripper assembly 22, 42. In some implementations, the main supports 28, 48 are fixedly attached to or through a planar or substantially planar surface 29, 43, which supports the pizza dough during placement of the ingredients.

The pair of illustrative distribution devices 16 differs primarily in the design and function of the robotic arms 21, 41. For example, the robotic arm 21 in FIG. 2A includes a plurality of points of rotation 23, 25, and 27 about which arm portions 24 and 26 rotate and articulate. The axes of these points of rotation 23, 25, and 27 lie in horizontal or substantially horizontal xy-planes. Hence, arm portions 24 and 26 can be articulated in a substantially vertical (z-axis) direction, to position a discrete dispensing device 30 at a desired height. The linearity of the arm portions 24 and 26 about point of rotation 25 enables the distribution device 16 to vary the y-axis position. Advantageously, the main support 28 is capable of rotating at least 180 degrees about the z-axis, which enables the distribution device 16 to vary the x-axis position.

In contrast, the robotic arm 41 in FIG. 2B includes a plurality of points of rotation 45, and 47 about which arm portions 44 and 46 rotate and articulate. The axes of these points of rotation 45 and 47 are vertical or substantially vertical, such that the axes are parallel or substantially parallel to the z-axis. In operation, arm portions 44 and 46 can be rotated about these axes 45 and 47 to articulate horizontally or substantially horizontally (in an xy-plane) to position a dispensing device 30 at a desired discrete location in the xy-plane. Advantageously, the main support 48 may be capable of being raised and lowered in a vertical or substantially vertical (z-axis) direction, which enables the distribution device 16 to vary the height of dispensing device 30. Alternatively, the gripper assembly 42 may be capable of being raised and lowered in a vertical or substantially vertical (z-axis) direction, which enables the distribution device 16 to vary the height of dispensing device 30.

The gripper assembly 22, 42 may be disposed at the distal end of the distribution device 16 and structured and arranged to acquire a discrete ingredient container 30, to position the ingredient container 30 at a desired height and at a discrete location above the pizza, to dispense a desired volume or weight of the ingredient contained in the ingredient container 30 at the discrete location, and to return the ingredient container 30 to its appropriate opening 49 in the dispensing rack 40. The gripper assembly 22, 42 may include a contoured contact surface that is adapted to accommodate the shape of the elongate ingredient container 30 and to hold and transport the ingredient container 30 to a desired position, height, and attitude above the pizza.

In some implementations, the gripper assembly 22, 42 includes an electro-magnetic device that may be selectively activated, e.g., by the processing device 15, to secure the outer portion 50 of a desired ingredient container 30. In other implementations, at least one gripper pad is fixedly attached to each of a pair of gripper ends at the distal end of the gripper assembly 22. The gripper pads can be made of any material, e.g., rubber, plastic, leather, and so forth, to cushion the gripping force that the gripper assembly 22, 42 applies to the ingredient container 30 and also to provide a friction surface to ensure that the ingredient container 30 does not displace vertically or otherwise slip out of the grip of the gripper assembly 22. The pair of gripper ends may be selectively activated, e.g., by the processing device 15, to secure the desired ingredient container 30.

In some variations, the gripper assembly 22, 42 includes a mechanical rod that is adapted and sized to mate with the rotary mechanical interface 35 of an ingredient container 30. For example, in operation, when the gripper assembly 22, 42 acquires a desired ingredient container 30, an end portion of the mechanical rod may be introduced into an opening in the rotary mechanical interface 35. A rotating device that may be integrated into the gripper assembly 22, 42 rotates the mechanical rod to open one or more of the dispensing vanes 38 of the ingredient container 30. The rotating device and the mechanical rod are configured to control not only which dispensing vane 38 is opened but also the extent of the opening.

As an alternative to a system using a mechanical rod and a rotary mechanical interface 35, in another implementation, the mechanical devices can be replaced by a magnetic system in which a magnet portion associated with the gripper assembly 22, 42 is structured and arranged to mate with a magnet portion that replaces the mechanical interface 35 associated with the ingredient container 30. The gripper assembly 22, 42 magnet portion may be selectively rotated, e.g., by the processing device 15, to rotate the corresponding magnet portion of the ingredient container 30. Rotation of the magnet portions control which dispensing vane 38 is opened as well as the extent of the opening.

The electrical contacts are provided to support having a plurality of complicated ingredient containers 30 that are controlled by a single rotary mechanical coupling. In one implementation, there are at least four (4) contacts. At least two of the four contacts provide power to and ground the container 30. At least two further contacts are provide for communication with the processing device 15, e.g., via a bus 18. Advantageously, the containers 30 for dispensing ingredients can be “future-proofed” with additional contacts to provide for unexpected future needs or functions. For example, additional contacts may be provided to enable a standardized interface to control every aspect of the movement of the container 30 as well as to gather information about its status, e.g., ingredient contained, remaining volume or weight of ingredient, and so forth.

FIG. 2C shows yet another embodiment of a distribution and dispensing device 16 that comprises a rotary plate 55 in conjunction with a gantry 60. The rotary plate 55 is structured and arranged to support the object and, moreover, adapted to rotate 360 degrees in order to position any portion of the object beneath the gantry 60 and a plurality of ingredient containers 59a-59c. The gantry 60, which may include an overhead cam 58 that is supported by a first support 56 and a second support 57, is structured and arranged to support a dispensing device 59, e.g., a plurality of ingredient containers 59a-59c, and to enable the dispensing device 59 to translate 54 along the overhead cam 58 to discrete locations above the rotary plate 55. The translation 54 of the dispensing device 59 and the rotation of the rotary plate 55 ensure that ingredients may be applied to every portion of the object.

In some applications of the embodiment, the dispensing device 59 is structured and arranged similar to a printer ink cartridge that includes a plurality of individually replaceable containers, each container holding a discrete ink color, e.g., cyan, magenta, yellow, and black. In the present application, each of the individual, replaceable containers 59a-59c would be structured and arranged to contain a desired ingredient. Hence, the dimensions of the containers 59a-59c and the dispensing openings will vary depending on the ingredient. In operation, the processing device 15 may control a motor to rotate the rotary plate 55 and to move the dispensing device 59 to a desired location above the object. Once the dispensing device 55 is positioned at a desired location, the processing device 15 can activate the opening means of one or more of the individual containers 59a-59c, causing a desired amount of the ingredient to fall onto a desired portion of the object.

Referring back to FIG. 1, embodiments of the invention may further be practiced using a communications network 20 to enable remote consumers to make orders and provide desired images for their order, e.g., using a processing device 25. A communications network 20 generally connects a client with a server, and in the case of peer-to-peer communications connects two peers. Communication may take place via any media such as standard telephone lines, LAN or WAN links (e.g., T1, T3, 56 kb, X.25), broadband connections (ISDN, Frame Relay, ATM), and wireless links (802.11, Bluetooth, 3G, CDMA, etc.). The communications network 20 may take any form, including but not limited to a local area network (LAN), a wide area network (WAN), a wireless network (WiFi, WiMAX), and a near-field network (RFID, Bluetooth), and may use any underlying protocol(s) that can transmit Internet protocols, including but not limited to Ethernet, ATM, and VPNs (PPPoE, L2TP, etc.), and encryption (SSL, IPSec, etc.).

At the client end, embodiments of the invention may be practiced with any computer system configuration, including hand-held wireless devices 25 such as mobile or cellular telephones, tablet computers, smartphones, smartpads, smartwatches, Google® Glasses, multiprocessor systems, microprocessor-based or programmable consumer electronics, minicomputers, mainframe computers, computers running under virtualization, etc. Advantageously, a consumer may use her cellphone or other wireless device 25 to place an order and to transmit a desired image for replication.

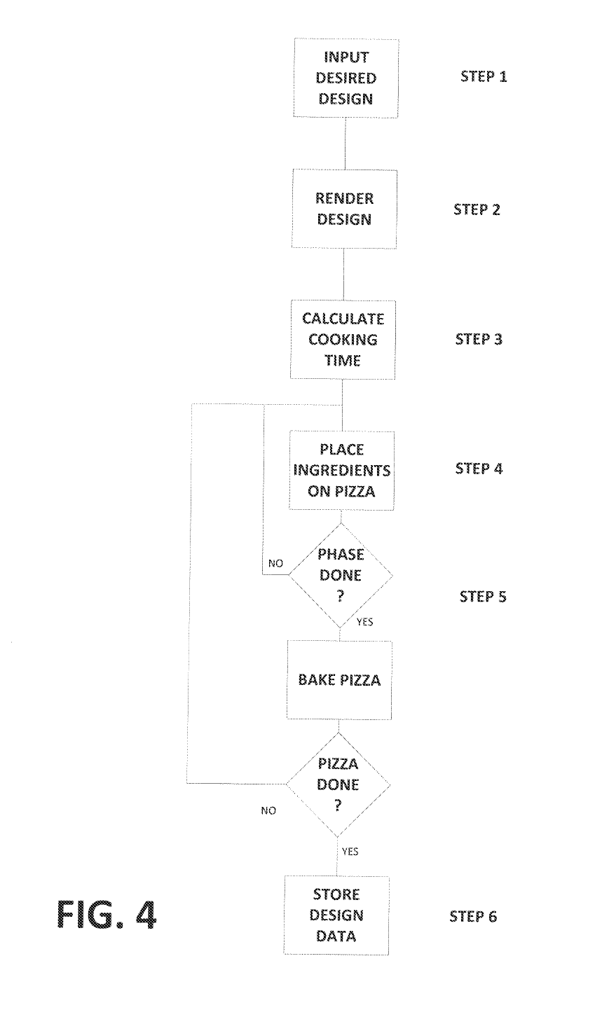

Having described a system for placing three-dimensional items on a surface of an object, a method of doing the same will now be described. Once again, for convenience, the method will be described in the context of the object being a pizza and the items including a plethora of prepared pizza ingredients. The invention, however, is not to be construed as being limited thereto. A flow chart of an illustrative embodiment of such a method is shown in FIG. 4. While the steps of the illustrative method will be described in a logical order, during practice of the method some of the steps may be performed simultaneously or out of the described order.

In a first step, the consumer introduces or inputs a desired design (STEP 1) into the system. The design may come from a variety of sources. For example, the consumer may already have a digital or electronic image that is uploaded on a personal processing device, e.g., a personal computer, a laptop computer, a tablet computer, a cellular phone, and so forth, or may scan a desired image, e.g., a photograph, a picture in a book or magazine, and the like, using an image processing device. Alternatively, the consumer may provide or input an electronic or digital sketch that she draws using commercially-available software and an input device at the time of the order. The sketch software tracks and records the consumer's movement of a mouse, her finger, a digital pen, and so forth and receives any colors assigned to discrete portions of the sketch.

When introducing or inputting a desired design, consumers may also draw from any of a stock set of images that are readily available in the public domain, e.g., “clip art,” may select a licensable image or an image subject to copyright (e.g., a sports team logo, a cartoon or comic character, a movie star, and so forth), may use a design created by another consumer, and/or may use a design that the consumer has previously used (STEP 1). The system processes the desired design to render the design (STEP 2) using ingredients having specific colors and tactile features on the surface of the pizza. Processing (STEP 2) includes, inter alia, associating a color with and assigning a color to an ingredient, e.g., black with olives, red with pepperoni, green with green peppers, white with mushrooms, and so forth, as well as determining two-dimensional (x, y) coordinates for laying out the discrete ingredients on the surface of the pizza and the order of placement of the ingredients. During processing (STEP 2) the system software may be adapted to take into account ingredient costs, ingredient availability, ingredient cooking time, relative cooking time of ingredients, ingredients wanted/not wanted by the consumer, visual aesthetics, visual similarity to the input design, the time and cost to place the ingredients on the pizza, and/or the shifting and/or morphing (e.g., shrinkage, deformation, expansion, and the like) of the ingredients during baking The processed data may then be saved, e.g., in a data storage device provided for that purpose, so that the design can be replicated immediately or at a later date by the same consumer or by another consumer.

Data for stock images, user-provided images, previously-used images, and the like may be saved as an image data file, e.g., JPG, GIF, BMP, and the like. In some embodiments, the image data files are stored in a raster format as a series of “pixels,” with each pixel having an associated color/food ingredient. Advantageously, rastering pixels facilitates vectoring, whereby groups or related regions of the same color (ingredient) may be defined spatially by mathematical curves. Once vectoring is completed, regions having the same color may be matched with a myriad of stock pattern images that are mathematically-described, e.g., circles, triangle, trapezoids, rectangles, and so forth. An exemplary format for image file data for an image may include a list of the ingredient series, wherein each ingredient series includes the ingredient and it's associated “ingredient drop.” The ingredient drop can include the three-dimensional (x, y, z) location, as well as the attitude (i.e., the roll, pitch, and yaw) of the distribution device with respect to the surface and the origin of the pizza.

In some embodiments, the processing device 15 is further structured and arranged to provide an image, e.g., display on a display device, of what the completed pizza will likely look like after all of the ingredients are applied to the pizza dough and the pizza has been cooked. This feature enables consumers to preview the appearance of the final product.

Advantageously, processing (STEP 2) can also include estimating the amount and weight of each ingredient for the purpose of calculating a cooking time (STEP 3). More specifically, a cooking time by weight or volume of each ingredient may be known or estimated. Accordingly, given the weight/volume of each added ingredient as well as the distribution of the ingredients over the pizza, the system can determine the amount of time it will take to bake properly (STEP 3). Those skilled in the art of pizza-making also realize that applying ingredients and cooking the pizza may be done in stages or phases as some ingredients that require less cooking time may be added in a second stage after the pizza has been cooked with first stage ingredients. Accordingly, processing (STEP 2) may include the preparation and cooking of the pizza in stages or phases.

When a consumer selects a stock image design that has been previously used, a user-provided design that has been previously used, and/or any other previously-used design, the vectoring, ingredient placement, and cooking time will have been saved along with the specific ingredient, ingredient placement order, and ingredient placement location data unique to the previously-prepared design. Hence, in this instance, calculating the cooking time (STEP 3) may only involve retrieving cooking time data from data storage.

Once the image has been processed (STEP 2), the ingredients may be placed on the surface of the pizza (STEP 4). The “ingredient series” of the image file data specifies the order of placement and the “ingredient drop” data provide the position, i.e., the three-dimensional (x, y, z) location, as well as the attitude, i.e., the roll, pitch, and yaw, of the distribution device with respect to the surface and the origin of the pizza. For example, the robotic actuator arm of the distribution device will secure the dispensing device containing a first ingredient, position the dispensing device over a corresponding location (x, y, z) of the pizza and at its desired attitude (pitch, roll, and yaw), and dispense the ingredient within a first region at a desired density before proceeding to a second or other regions, which may or may not have the same distribution density as the first region.

Release mechanisms may vary according to the ingredient to be dispensed. For example, some ingredients may be applied as a viscous fluid, e.g., tomato sauce, which requires a pouring or a squirting application mechanism, and other ingredients, such as solids (e.g., pepperoni, olives, onions, pineapple, bacon, peppers), may require a gravity mechanism that includes a dispensing mechanism, e.g., one or more dispensing vanes, that can be selectively activated to provide an opening having a controllable dimension. Indeed, among solid ingredients, gravity mechanisms and the dimensions of the opening vary as a function of the ingredient, e.g., its shape, its size, its weight, and so forth. As described above, the degree and amount of rotation of the mechanical rod of the gripper assembly after the tip of the mechanical rod has been inserted into the mechanical interface of the container determines which dispensing vane(s) is opened and the distance the vane(s) is opened. The former provides greater control of the placement of the food ingredient while the latter facilitates the volume of food ingredients that are distributed when distribution, i.e., dropping, of more than one unit of the food ingredients is desired.

Advantageously, the path that the robotic actuator arm follows to the ingredient drop location(s) can be optimized to be cost effective. When the first ingredient has been placed on each appropriate region of the pizza, the distribution device returns the dispensing device to the tray and the robotic actuator arm of the distribution device will secure another dispensing device containing a second ingredient. This process continues until each of the ingredients in the ingredient series for the particular stage or phase has been placed onto the surface of the pizza.

After each of the ingredients of the series for the particular stage or phase has been added to the pizza, the pizza may be inserted into a pizza oven, where it can be cooked (STEP 5) for the pre-determined amount of time (STEP 3). After the pre-determined amount of time, the pizza may be removed from the oven and, if removal occurs after the final stage or phase, served to the consumer. On the other hand, if the pizza is removed and there are additional stages or phases, then STEPS 4 and 5 are repeated until all stages or phases have been completed.

In some implementations, data associated with the completed pizza, including without limitation an image of the design, the ingredients by type and weight or volume, the preparation time, the cooking time, the order of ingredient placement, the staging or phasing of application and cooking, and the location, height, and attitude of each ingredient application (STEP 6) is stored in a data storage device provided for that purpose.

Various embodiments and features of the present invention have been described in detail with particularity. The utilities thereof can be appreciated by those skilled in the art. It should be emphasized that the above-described embodiments of the present invention merely describe certain examples implementing the invention, including the best mode, in order to set forth a clear understanding of the principles of the invention. Numerous changes, variations, and modifications can be made to the embodiments described herein and the underlying concepts, without departing from the spirit and scope of the principles of the invention. All such variations and modifications are intended to be included within the scope of the present invention, as set forth herein. The scope of the present invention is to be defined by the claims, rather than limited by the forgoing description of various preferred and alternative embodiments. Accordingly, what is desired to be secured by Letters Patent is the invention as defined and differentiated in the claims, and all equivalents.

What is claimed is:

1. A system for placing three-dimensional food ingredients on a surface of an object, the system comprising:
a memory for storing computer executable instructions and for storing image data for a design to be placed on the surface of the object;
a processing device that is configured and arranged to execute the computer executable instructions stored in the memory;
a plurality of dispensing devices, each of the dispensing devices structured and arranged to contain a three-dimensional food ingredient; and
a distribution device that is structured and arranged to place, in response to an instruction from the processing device, a plurality of the three-dimensional food ingredients from the plurality of dispensing devices at discrete locations on the surface of the object.

2. The system of claim 1, wherein each of the plurality of dispensing devices is an elongate container that, in cross section, is at least one of circular, oval, rectangular, hexagonal, octagonal, or triangular.

3. The system of claim 2, wherein each container is structured and arranged to contain one of the food ingredients, each food ingredient having an associated color.

4. The system of claim 3, wherein each container comprises a delivery chute that is structured and arranged to deliver the food ingredient contained in the tube.

5. The system of claim 1, wherein at least one of the dispensing devices comprises a mechanical connection that is adapted to mate with the distribution device.

6. The system of claim 1, wherein at least one of the dispensing devices comprises an electrical connection that is adapted to mate with the distribution device.

7. The system of claim 1 further comprising a dynamic dispenser that is configured and arranged to replenish the dispensing devices with a corresponding three-dimensional food ingredient.

8. The system of claim 1, wherein the object is a good to be baked.

9. The system of claim 1, wherein the distribution device comprises at least one of a robotic arm and a rotary plate and overhead cam.

10. The system of claim 1 further comprising an image processing device that is configured and arranged to generate, based on an input image, the image data for the design to be placed on the surface of the object.

11. The system of claim 1, wherein the memory is configured to store at least one of:
historical data of previously completed images;
prepared image data; and
input image data.

12. A method for placing three-dimensional food ingredients on a surface of an object, the method comprising:
receiving an image of a design to be placed on the surface of the object;
associating at least one discrete portion of the image with one of the three-dimensional food ingredients;
determining vectors for delivering the three-dimensional food ingredients to discrete locations on the surface of the object; and
placing the three-dimensional food ingredients at the discrete locations on the surface of the object.

13. The method of claim 12, wherein associating the at least one discrete portion of the image comprises comparing a color in the image with a color of each of the three-dimensional food ingredients.

14. The method of claim 12, wherein receiving the image of the design comprises at least one of:
receiving a scan of a document displaying the image;
receiving a previously used image design; and
receiving a prepared design.

15. The method of claim 12 further comprising calculating a cooking time for the object.

16. The method of claim 15, wherein calculating the cooking time for the object comprises taking into account all of the three-dimensional food ingredients that have been placed on the surface of the object.

17. An article of manufacture, comprising a non-transitory machine-readable medium having machine-readable instructions stored thereon that, when executed by a machine, configure the machine to:
receive an image of a design to be placed on a surface of an object;
associate at least one discrete portion of the image with a three-dimensional food ingredient;
determine vectors for delivering a plurality of three-dimensional food ingredients to discrete locations on the surface of the object; and
place the three-dimensional food ingredients at the discrete locations on the surface of the object.

18. The article of manufacture of claim 17, wherein the machine, in associating the at least one discrete portion of the image, compares a color in the image with a color of each of the three-dimensional food ingredients.

19. The article of manufacture of claim 17 further comprising instructions that, when executed by the machine, configure the machine to calculate a cooking time for the object.

20. The article of manufacture of claim 19, wherein the machine, in calculating the cooking time, takes into account all of the three-dimensional food ingredients that have been placed on the surface of the object.

21. The article of manufacture of claim 17 further comprising instructions that, when executed by the machine, configure the machine to cause the three-dimensional food ingredients to be replenished.
